(19) United States
(12) Patent Application Publication
(10) Pub. No.: US 2023/0415809 A1
(43) Pub. Date: Dec. 28, 2023

(54) METHOD FOR OPERATING A STEER-BY-WIRE STEERING SYSTEM, AND STEER-BY-WIRE STEERING SYSTEM

(71) Applicant: ZF Automotive Germany GmbH, Alfdorf (DE)

(72) Inventors: Stephan Walentowski, Düsseldorf (DE); Stefan Jäkel, Düsseldorf (DE); Thomas Zimmermann, Düsseldorf (DE)

(21) Appl. No.: 18/342,308

(22) Filed: Jun. 27, 2023

(30) Foreign Application Priority Data
Jun. 27, 2022 (DE) 102022206408.9

(51) Int. Cl. B62D 5/04

(52) U.S. Cl. CPC B62D 5/0466

(57) ABSTRACT

A method is disclosure for operating a steer-by-wire vehicle steering system with a steering wheel in a shut-down state of the vehicle. According to one step of the method, after the vehicle has been shut down a procedure is carried out to monitor whether the steering wheel of the vehicle is being moved. If a movement of the steering wheel is ascertained and the movement exceeds a defined first limiting value, the movement of the steering wheel is damped by a damping unit of the steering system. If no movement of the steering wheel exceeding the first limiting value was ascertained for a defined time period, no further monitoring of a movement of the steering wheel and no further damping of the movement of the steering wheel are undertaken, so long as the vehicle is shut down. If, alternatively or additionally, a movement of the steering wheel exceeds a second limiting value, which is lower than the first limiting value, but does not exceed the first limiting value was ascertained within the defined time period and it is ascertained on the basis of an evaluation of the movement profile of the movement of the steering wheel that the movement was not caused by a user, likewise no further monitoring of a movement of the steering wheel and also no further damping of the movement of the steering wheel are undertaken, so long as the vehicle is shut down. Moreover, a steer-by-wire steering system for a vehicle is specified.

### CROSS-REFERENCE TO RELATED APPLICATION

This application claims priority to German Priority Application No. 102022206408.9, filed Jun. 27, 2022, the disclosure of which is incorporated herein by reference in its entirety.

### TECHNICAL FIELD

The disclosure relates to a method for operating a steer-by-wire steering system of a vehicle with a steering wheel in a shut-down state of the vehicle, and also to a steer-by-wire steering system.

### BACKGROUND

Steering systems ordinarily include a rack which is supported so as to be linearly displaceable for the purpose of adjusting a wheel position. A rack of such a type has hitherto been coupled with the steering wheel via a steering rod, so that a linear displacement of the rack is obtained by a rotation of the steering wheel.

In future, vehicles with so-called steer-by-wire steering systems (SbW steering systems), in which there is no longer any mechanical connection between the steering wheel and the rack, will be used to an increased extent. The position of the steering wheel is detected electronically, and a corresponding displacement of the rack is obtained by an electric drive. In addition, the steering wheel is actively damped by a damping unit, in order to simulate a roadway resistance or a resistance of the steering system on the steering wheel.

By reason of the absence of the mechanical connection between the steering wheel and the rack, the steering wheel is able to rotate relatively freely in a de-energized state of the damping unit, for instance whenever the vehicle has been parked. In particular, in a shut-down state of the vehicle merely the system friction of the steering system is active, which in the case of a steer-by-wire steering system is relatively slight in comparison with a steering system with a steering rod.

However, an active rotation of the steering wheel in the shut-down state—for instance, when a child is playing in the shut-down vehicle—is to be avoided, in order to treat the mechanical components of the steering system with care and to avoid an undamped striking of the steering wheel against an end stop. In addition to this, an undamped rotary capacity of the steering wheel is perceived by users to be unsophisticated. However, a permanent damping of the steering wheel in a shut-down state of the vehicle is disadvantageous, since the vehicle battery may discharge in the event of relatively long shut-down times of the vehicle.

### SUMMARY

What is needed is to be able to enable the damping of a movement of the steering wheel in a shut-down state of the vehicle with low consumption of energy.

In accordance with the disclosure, a method for operating a steer-by-wire steering system of a vehicle with a steering wheel in a shut-down state of the vehicle. According to one step of the method, after the vehicle has been shut down, a procedure is carried out to monitor whether the steering wheel of the vehicle is being moved. If a movement of the steering wheel is ascertained and the movement exceeds a defined first limiting value, the movement of the steering wheel is damped by a damping unit of the steering system. If no movement of the steering wheel that exceeds the first limiting value was ascertained for a defined period of time, no further monitoring of a movement of the steering wheel and also no further damping of the movement of the steering wheel are undertaken, so long as the vehicle is shut down. If, alternatively or additionally, a movement of the steering wheel that exceeds a second limiting value, which is lower than the first limiting value, but does not exceed the first limiting value was ascertained within the defined period of time and it is ascertained on the basis of an evaluation of the movement profile of the movement of the steering wheel that the movement was not caused by a user, likewise no further monitoring of a movement of the steering wheel and also no further damping of the movement of the steering wheel are undertaken, so long as the vehicle is shut down.

By “a shut-down state of the vehicle”, a state is meant in which the vehicle is stationary and the engine/motor is off—for example, whenever the vehicle is parked.

By virtue of the method according to the disclosure, an advantage is obtained that immediately after the shutdown of the vehicle the movement of the steering wheel is still monitored for a certain period of time, and a damping of the steering wheel can be undertaken. However, if it is considered unlikely that the steering wheel will be moved while the vehicle is shut down, because no movement of the steering wheel was ascertained for a defined period of time, or only those movements were ascertained which were not caused by a user, both the monitoring and the damping of the steering wheel can be discontinued, and the corresponding systems are switched off. In this way, a persistent consumption of electrical energy is avoided. This means that in the event of relatively long periods where the vehicle is stationary the vehicle battery is not discharged by the monitoring system and the damping unit.

However, by virtue of the monitoring of the movement of the steering wheel and, where appropriate, the damping of the movement of the steering wheel by the damping unit, it is guaranteed that the steering system is not damaged by undamped striking of the steering wheel against an end stop. In addition, a damped movement of the steering wheel, even in a shut-down state of the vehicle, is perceived to be sophisticated.

Inasmuch as only those movements are damped which exceed a first limiting value, only those movements of the steering wheel are damped in the case of which a movement is caused by a user and consequently a damping is actually capable of being perceived by a user or there is a risk that the steering wheel will strike against an end stop. This likewise contributes to savings of energy in the steering system.

Movements of the steering wheel that exceed the first limiting value are, for example, those movements which are caused unequivocally by an active movement of the steering wheel; for example, whenever a user or, where appropriate, a child, or a pet left in the car, bumps against or turns the steering wheel.

Movements that lie between the first and second limiting values cannot be assigned unequivocally to a user by the monitoring unit without further analysis—that is to say, without evaluation of the movement profile of the movement of the steering wheel.

Movements of the steering wheel that lie below the second limiting value are so slight that they may be disregarded. Such slight movements arise, for instance, by reason of vibrations of the roadway when the vehicle has been shut down at the side of a road, for instance.

Movements of the steering wheel that lie between the first limiting value and the second limiting value may be caused, for instance, by a user but also by intense vibrations of the roadway or by gusts of wind or similar excitations of the vehicle, or when the vehicle is being transported on a car train, for instance.

The evaluation of the movement profile for the purpose of ascertaining whether a movement of the steering wheel was caused by a user involves, for instance, the ascertainment of how often the steering wheel was moved and at what frequency the steering wheel was moved. A high frequency indicates, for instance, that a movement was induced by vibrations in a vicinity of the vehicle.

The monitoring of a movement of the steering wheel takes place, for instance, by a monitoring unit which is able to access and evaluate the sensors already present in the vehicle.

A movement of the steering wheel can be detected on the basis of a rotational speed of the steering wheel and/or on the basis of a change in the position of the steering wheel. In this way, a movement of the steering wheel can be detected with particularly high accuracy.

For instance, an angle sensor or a position sensor of the damping unit may serve for detecting the movement of the steering wheel.

In one exemplary arrangement, the damping unit is switched off for the time being when the vehicle is being shut down. This means that the damping unit is activated only when a damping of the movement of the steering wheel is actually required—that is to say, when the movement of the steering wheel has exceeded the first limiting value, for instance. This likewise contributes distinctly to a reduction of the power consumption in the shut-down state of the vehicle.

According to one exemplary arrangement, a period of monitoring after the shutdown of the vehicle is extended if after the shutdown of the vehicle a movement of the steering wheel that exceeds a first limiting value is ascertained within the defined period of time. By virtue of the extending of the period of monitoring, it is ensured that no movement of the steering wheel that requires damping eludes the monitoring system.

A monitoring of the movement of the steering wheel is intensified if an ascertained movement of the steering wheel lies between the first and second limiting values. For instance, additional sensors of the steering system—such as a torque sensor—are activated. By virtue of an intensification of the monitoring, it can be ascertained with greater certainty whether a movement of the steering wheel was caused by external excitations of the vehicle or by a contact with the steering wheel.

After the shutdown of the vehicle, a timer can begin to run, the running-time of which corresponds to the defined period of time, the timer being reset to a starting value if an active movement of the steering wheel, for example, a movement that was caused by a user, was ascertained within the running-time. This means that when the timer has run down no appreciable movement of the steering wheel has taken place for a defined period of time, and the monitoring unit as well as the damping unit—to the extent that this was activated—are switched off. By virtue of the resetting of the timer, it is therefore ensured that the period of monitoring after shutdown of the vehicle is extended if a movement of the steering wheel beyond the first limiting value has taken place.

It is conceivable that a detected movement profile of the steering wheel is evaluated by an algorithm, and the monitoring of the movement of the steering wheel is terminated if the movement profile indicates that the movement of the steering wheel was not caused by a user. Such movement profiles may have been created by test vehicles or simulations, and may have been saved as standard patterns in the monitoring unit. By such an evaluation, the situation can likewise be avoided where the monitoring remains active for an excessively long time.

A steer-by-wire steering system for a vehicle is also disclosed, which, has been set up to execute a method according to the disclosure, with a steering wheel, with a damping unit which has been set up to damp, in an active state, a movement of the steering wheel, and with a monitoring unit which has been set up to detect a movement of the steering wheel in an inactive state of the damping unit and to activate the damping unit if the detected movement of the steering wheel exceeds a first limiting value. The monitoring unit has, in addition, been set up to activate the damping unit if the detected movement exceeds a second limiting value, which is lower than the first limiting value, and it was ascertained on the basis of an evaluation of the movement profile of the movement of the steering wheel that the movement was caused by a user. It is therefore possible to activate the damping unit only when a damping of the movement of the steering wheel is actually required, by virtue of which an unnecessary consumption of energy is avoided.

According to one exemplary arrangement, the steering system has been set up to deactivate the monitoring unit if no movement of the steering wheel that exceeds the first limiting value is detected within a defined period of time and/or a movement of the steering wheel that exceeds the second limiting value but not the first limiting value was ascertained within the defined period of time and it was ascertained on the basis of an evaluation of the movement profile of the movement of the steering wheel that the movement was not caused by a user. As already described in connection with the method according to the disclosure, this likewise contributes to a reduced consumption of energy.

### BRIEF DESCRIPTION OF DRAWINGS

Further advantages and features of the disclosure arise out of the following description and the accompanying drawings, to which reference is made. In the drawings:

FIG. 1 shows schematically a steering system according to the disclosure,

FIG. 2 shows a progression of the angular velocity of the steering wheel, and

FIG. 3 shows a flowchart that illustrates a method according to the disclosure.

### DETAILED DESCRIPTION

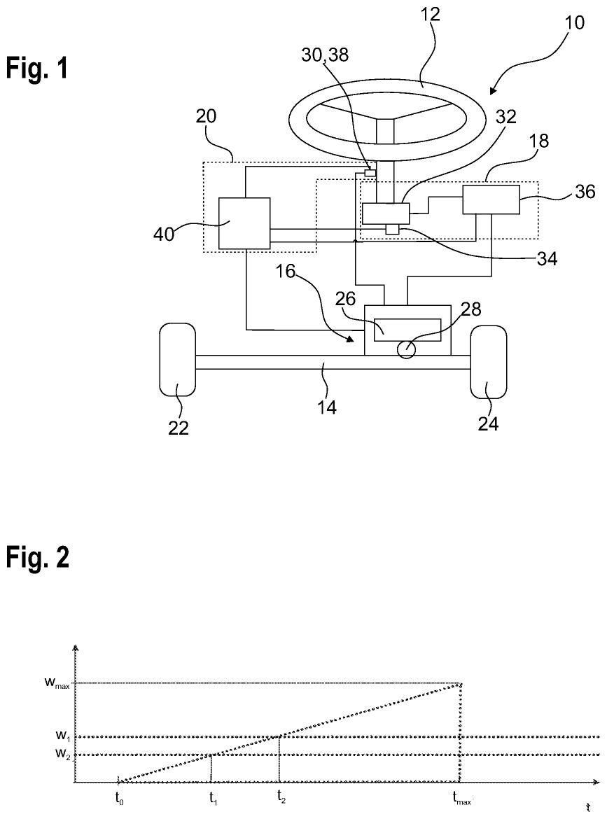

FIG. 1 illustrates schematically a steer-by-wire steering system 10 for a vehicle with a steering wheel 12.

The steering system 10 includes a rack 14. The rack 14 is connected to a wheel-carrier via tie rods, which for the sake of simplicity are not represented, in such a manner that a linear displacement of the rack 14 results in a rotation of the wheel-carriers about their steering axle.

Moreover, the steering system 10 includes an actuator unit 16, a damping unit 18 and a monitoring unit 20.

The actuator unit 16 serves for setting a wheel-positioning angle in respect of wheels 22, 24 of the vehicle on the basis of a steering angle of the steering wheel 12.

For this purpose, in the exemplary arrangement that is represented the actuator unit 16 includes a servomotor 26 and also a pinion 28 which engages the rack 14.

In an alternative exemplary arrangement, which for the sake of simplicity is not represented, the actuator unit 16 includes, instead of a rack 14 and a pinion 28, electromotive servo actuators, one servo actuator being assigned to each wheel 22, 24.

In the steer-by-wire steering system 10 there is no mechanical coupling between the steering wheel 12 and the wheels 22, 24. Instead, a wheel-positioning angle is set by the servomotor 26.

For this purpose, the pinion 28, which is in interlocked engagement with the rack 14, is rotated by the servomotor 26, as a result of which the rack 14 is moved linearly.

A sensor 30—which, for example, is an angle sensor—has been set up in order to detect a steering angle of the steering wheel 12.

On the basis of the detected steering angle, a wheel-positioning angle requirement is determined, and the actuator unit 16 is triggered accordingly.

The damping unit 18 has been set up to apply a torque to the steering wheel 12. For this purpose, the damping unit 18 includes a steering actuator 32.

In addition, the damping unit 18 includes a position sensor 34 which can detect a position of the steering actuator 32.

In addition, the damping unit 18 includes a control unit 36 for outputting a desired damping torque.

The damping unit 18 simulates a resistance in the course of steering on the steering wheel 12. As a result, the damping unit 18 damps movements of the steering wheel 12 and in this way prevents the steering wheel 12 from striking against an end stop at high speed. In addition, a haptic feedback is given to the driver by the damping.

The monitoring unit 20 has been set up to detect a movement of the steering wheel 12, for example also when the damping unit 18 has been switched off or is in a standby mode.

The movement of the steering wheel 12 can be detected on the basis of a rotational speed of the steering wheel and/or on the basis of a change in the position of the steering wheel.

The monitoring unit 20 includes at least one sensor 38 which has been set up to detect a movement of the steering wheel—for example, a speed of the steering wheel.

This sensor 38 may be, for instance, the same sensor 30 which detects the steering angle of the steering wheel 12.

However, it is also conceivable that the sensor 38 is a separate sensor.

In addition to this, the monitoring unit 20 may have been set up to access further sensors of the steering system 10—for example, the position sensor 34.

The monitoring unit 20 has been set up to activate the damping unit 18 if the detected movement of the steering wheel 12 exceeds a first limiting value.

In addition, the monitoring unit 20 has been set up to take a movement of the steering wheel into account only when this movement exceeds a second limiting value, which is lower than the first limiting value.

Movements that lie below the second limiting value are, for example, so slight that they are to be ignored.

The monitoring unit 20 has, in addition, been set up to activate the damping unit if the detected movement exceeds the second limiting value but not the first limiting value and it was ascertained on the basis of an evaluation of the movement profile of the movement of the steering wheel that the movement was caused by a user.

In addition to this, the steering system 10 has been set up to deactivate the monitoring unit 20—that is to say, to switch it off—if no movement of the steering wheel that was caused by a user is detected within a defined period of time. This means that no movement of the steering wheel is detected that exceeds the first limiting value or that lies between the first limiting value and the second limiting value and is assigned to a user by evaluation of the movement profile.

For the purpose of evaluating the detected movements of the steering wheel and also for the purpose of triggering and, where appropriate, deactivating the damping unit 18, the monitoring unit 20 likewise includes a control unit 40.

A movement of the steering wheel detected by the monitoring unit 20 is illustrated in FIG. 2. Such a movement of the steering wheel is possible in a shut-down state of the vehicle if the damping unit 18 has been deactivated.

The illustrated scenario arises, for instance, if a user turns the steering wheel 12 in the shut-down and switched-off state of the vehicle.

In the illustrated example, the angular velocity w or rotational speed of the steering wheel 12 increases continuously from time t₀ until tₘₐₓ. Prior to time t₀, the steering wheel 12 is at rest.

At time t₁, the speed of the steering wheel 12 reaches the value w₂, which corresponds to the second limiting value. In the exemplary arrangement, the monitoring unit 20 therefore takes the movement of the steering wheel into account starting from time t₁, whereas movements between t₀ and t₁ are ignored.

At time t₂, the speed of the steering wheel 12 reaches the value w₁, which corresponds to the first limiting value. In the case of movements that exceed the first limiting value, the monitoring unit 20 assumes, without further analysis, that these movements were caused by direct application of force to the steering wheel 12—that is to say, by a user who is located in the vehicle.

At time tₘₐₓ, an end stop has been reached, and the angular velocity of the steering wheel drops abruptly from wₘₐₓ to zero.

Such a striking of the steering wheel 12 against an end stop is to be avoided.

In accordance with an exemplary arrangement of the disclosure, there is therefore provision that the monitoring unit 20 activates the damping unit 18 as required, in order to damp a movement of the steering wheel 12.

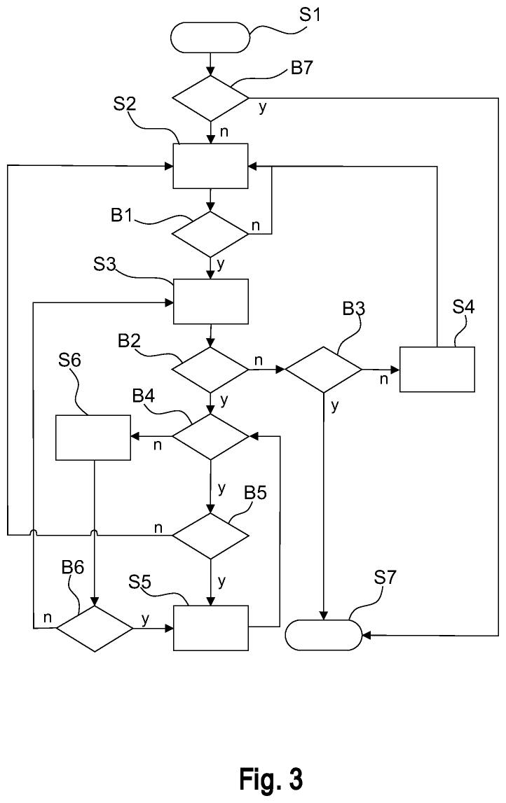

A method according to the disclosure for operating a steer-by-wire steering system 10 is illustrated in FIG. 3 on the basis of a flowchart.

In a step S1, the vehicle is shut down and switched off; more specifically, the engine/motor of the vehicle is switched off.

Immediately after the engine/motor has been switched off, the vehicle is in a state of rest, in which parts of the vehicle system may still be active.

In one exemplary arrangement, the monitoring unit 20 is still active for the time being.

With the shutdown of the vehicle, in addition a timer begins to run. The running-time of the timer corresponds to the defined period of time after which the monitoring unit 20 is to be deactivated if no movement of the steering wheel 12 was ascertained within the defined period of time. For instance, the running-time of the timer amounts to 20 minutes.

Accordingly, after the timer has run down, no further monitoring of a movement of the steering wheel 12 and also no further damping of the movement of the steering wheel take place, so long as the vehicle is shut down.

The damping unit 18 is switched off for the time being when the vehicle is being shut down.

The monitoring unit 20 monitors, in step S2, whether the steering wheel of the vehicle is being moved.

The measurement of a movement of the steering wheel can be undertaken either continuously or at fixed time-intervals. The time-intervals may be very short and may amount to 50 milliseconds, for instance.

If condition B1, that a fixed time-interval has elapsed, has arisen (labeled in the flowchart by y for “yes”), in step S3 an evaluation is undertaken in the monitoring unit 20 for the purpose of ascertaining a movement of the steering wheel 12.

If a condition is not satisfied, this is labeled in the flowchart by n for “no”.

If it is ascertained in step S3 that condition B2, according to which the second limiting value was exceeded, is satisfied, the timer continues to run for the time being.

Condition B3 implies that the timer has not yet run down in the course of the implementation of step S3.

If, in addition to condition B2, condition B4 is also satisfied, according to which the detected movement of the steering wheel exceeds the first limiting value, in step S5 the movement of the steering wheel 12 is damped by the damping unit 18. The time at which step S5 takes place corresponds to time t₂ in FIG. 2.

If condition B4 has arisen, the timer is reset to its initial value. Accordingly, if, after the shutdown of the vehicle, a movement of the steering wheel 12 that exceeds the first limiting value is ascertained within the defined period of time, a period of monitoring after the shutdown of the vehicle is extended.

If merely condition B2 is satisfied—that is to say, if an ascertained movement of the steering wheel 12 lies between the first and second limiting values—the movement profile of the movement of the steering wheel is evaluated, in order to ascertain whether the movement was caused by a user. If this is the case, the movement of the steering wheel 12 is likewise damped by the damping unit 18, and the timer is reset to its initial value.

Prior to the activating of the damping unit 18, a procedure is carried out to check whether condition B5—that the vehicle has been shut down—is actually satisfied.

For instance, a procedure is carried out to check whether the speed of the vehicle amounts to 0 km/h.

As a result, it is guaranteed that the damping unit 18 is not activated unintentionally during a trip.

If merely condition B2 is satisfied, in addition a monitoring of the movement of the steering wheel is intensified, this being undertaken in step S6. The intensification of the monitoring takes place, when it was not possible to ascertain unequivocally whether a movement of the steering wheel that lies between the first and second limiting values was caused by a user. The time at which step S6 takes place corresponds to time t₁ in FIG. 2.

An intensification of the monitoring is undertaken, for instance, by virtue of the fact that the monitoring unit 20 accesses further sensors in order to obtain additional measured values. For instance, in this case the monitoring unit 20 can access the position sensor 34 or a torque sensor which is not represented in the figures.

If, after the intensification of the monitoring, the monitoring unit 20 ascertains that condition B6 obtains, according to which an active movement of the steering wheel 12 has occurred, step S5 takes place, and the damping unit 18 is activated.

If the monitoring unit 20 ascertains that no active movement of the steering wheel 12 has occurred, step S3 is implemented again, and a movement of the steering wheel continues to be monitored.

If no active movement of the steering wheel 12 is ascertained within the defined period of time after the shutdown of the vehicle, the monitoring unit 20 and—to the extent that this was active—the damping unit 18 are switched off in step S7.

Consequently no further monitoring of a movement of the steering wheel occurs.

It is conceivable that a detected movement profile of the steering wheel 12 is evaluated, in the control unit 40 of the monitoring unit 20 by an algorithm, in order to ascertain whether or not an ascertained movement of the steering wheel has been undertaken by a user.

In addition, it is possible that under certain conditions, which are labeled in the flowchart by B7, a monitoring of a movement of the steering wheel from the beginning is dispensed with. Such a condition is, for instance, that a vehicle is intended for transportation on a car train. If condition B7 is satisfied, step S7 is undertaken directly, and the monitoring unit 20 is deactivated.

1. A method for operating a steer-by-wire steering system of a vehicle with a steering wheel in a shut-down state of the vehicle, the method comprising:
after a vehicle has been shut down, a procedure is carried out to monitor whether the steering wheel of the vehicle is being moved,
if a movement of the steering wheel is ascertained and the movement exceeds a defined first limiting value, the movement of the steering wheel is damped by a damping unit f the steering system,
if no movement of the steering wheel that exceeds the first limiting value was ascertained for a defined period of time and/or a movement of the steering wheel that exceeds a second limiting value, which is lower than the first limiting value, but does not exceed the first limiting value was ascertained within the defined period of time and it is ascertained based on an evaluation of a movement profile of the movement of the steering wheel that the movement was not caused by a user, no further monitoring of movement of the steering wheel and also no further damping of the movement of the steering wheel are undertaken, so long as the vehicle is shut down.

2. The method as claimed in claim 1, wherein a movement of the steering wheel is detected based on a rotational speed of the steering wheel and/or based on a change in a position of the steering wheel.

3. The method as claimed in claim 1, wherein the damping unit is switched off when the vehicle is being shut down.

4. The method as claimed in claim 1, wherein a monitoring period after the shut down of the vehicle is extended if after the shut down of the vehicle a movement of the steering wheel that exceeds the first limiting value is ascertained within the defined period of time.

5. The method as claimed in claim 1, wherein monitoring of the movement of the steering wheel is intensified if an ascertained movement of the steering wheel lies between the first limiting value and the second limiting value.

6. The method as claimed in claim 1, wherein after the shut down of the vehicle, a timer begins to run, the running-time of which corresponds to the defined period of time, the timer being reset to a starting value if an active movement of the steering wheel was ascertained within the running-time.

7. The method as claimed in claim 1, wherein a detected movement profile of the steering wheel is evaluated by an algorithm, and the monitoring of the steering wheel movement is terminated if the movement profile indicates that the steering wheel movement was not caused by a user.

8. A steer-by-wire steering system for a vehicle, which has been set up to execute a method as claimed in claim 1, comprising: a steering wheel, with a damping unit which is configured to damp, in an active state, a movement of the steering wheel, and with a monitoring unit which has been set up to detect a movement of the steering wheel in an inactive state of the damping unit and to activate the damping unit if the detected movement of the steering wheel exceeds a first limiting value or the detected movement exceeds a second limiting value, which is lower than the first limiting value, but does not exceed the first limiting value and it was ascertained on the basis of an evaluation of the movement profile of the movement of the steering wheel that the movement was caused by a user.

9. The steer-by-wire steering system as claimed in claim 8, wherein the steering system is configured to deactivate the monitoring unit if no movement of the steering wheel that exceeds the first limiting value is detected within a defined period of time and/or a movement of the steering wheel that exceeds the second limiting value but does not exceed the first limiting value was ascertained within the defined period of time and it was ascertained based on an evaluation of the movement profile of the movement of the steering wheel that the movement was not caused by a user.

10. The method as claimed in claim 2, wherein the damping unit is switched off when the vehicle is being shut down.

11. The method as claimed in claim 10, wherein a monitoring period after the shut down of the vehicle is extended if after the shut down of the vehicle a movement of the steering wheel that exceeds the first limiting value is ascertained within the defined period of time.

12. The method as claimed in claim 11, wherein monitoring of the movement of the steering wheel is intensified if an ascertained movement of the steering wheel lies between the first limiting value and the second limiting value.

13. The method as claimed in claim 12, wherein after the shut down of the vehicle, a timer begins to run, the running-time of which corresponds to the defined period of time, the timer being reset to a starting value if an active movement of the steering wheel was ascertained within the running-time.

14. The method as claimed in claim 13, wherein a detected movement profile of the steering wheel is evaluated by an algorithm, and the monitoring of the steering wheel movement is terminated if the movement profile indicates that the steering wheel movement was not caused by a user.
